(19) United States
(12) Patent Application Publication
(10) Pub. No.: US 2014/0223893 A1
(43) Pub. Date: Aug. 14, 2014

(54) PILOT PUMP SOURCED PEAK SHAVING FOR HYBRID HYDRAULIC CIRCUITS

(71) Applicant: CATERPILLAR INC., Peoria, IL (US)

(72) Inventors: Jeremy Todd Peterson, Washington, IL (US); Jeffrey L. Kuehn, Germantown Hills, IL (US)

(73) Assignee: CATERPILLAR INC., Peoria, IL (US)

(21) Appl. No.: 13/764,024

(22) Filed: Feb. 11, 2013

(51) Int. Cl. F15B 1/02

(52) U.S. Cl. CPC F15B 1/024
USPC 60/325; 137/565.11; 137/14

(57) ABSTRACT

A system includes a pilot pump with an output that may be directed to a pilot circuit by way of a selector valve. The selector valve is shifted between a first position providing communication between the pump and the pilot circuit to a second position providing communication between the pilot pump and the hybrid circuit when pressure in the pilot circuit reaches a predetermined level. That pressure is used to hydraulically shift the selector valve to redirect flow from the pilot pump to the hybrid circuit. Both the pilot circuit and the hybrid circuit include accumulators for storing pressurized hydraulic fluid. The fluid stored in the pilot circuit is used for pilot functionality while the fluid stored in the hybrid circuit is used to power any one or more of a variety of power consuming components.

### TECHNICAL FIELD

This disclosure relates generally to hydraulic circuits, and more specifically, this disclosure relates to hybrid hydraulic circuits with a means for utilizing excess pressurized fluid from a pilot system.

### BACKGROUND

Hybrid hydraulic circuits are used to capture, store and reuse either kinetic energy or braking energy on a machine to improve efficiency. For example, U.S. Pat. No. 7,908,852 discloses machines, such as excavators, that include a swing mechanism which enable an upper structure to be rotated about a base machine on a central pivot by a hydraulic swing motor. The hydraulic swing motor is part of a hydraulic circuit that includes a directional control valve configured to control the swing motor. The large mass and geometry of the upper structure of the machine create high inertial loads when the upper structure is rotated.

The '852 patent discloses a hydraulic system and method for recovering the kinetic energy generated by the operation of a swing motor, converting the kinetic energy into hydraulic potential energy, and reusing the hydraulic potential energy for swing motor acceleration to improve the machine productivity and fuel efficiency of the overall system. The hydraulic system includes an accumulator for collecting kinetic energy caused by the motion of the swing motor. The accumulator stores exit fluid from the swing motor that is pressurized by the inertia torque applied on the moving motor via movement of an upper structure of the machine, such as an excavator. The stored pressurized exit fluid in the accumulator can then be used to accelerate or decelerate the swing motor.

Instead of, or in addition to, using stored pressurized fluid to assist in accelerating or decelerating the motor responsible for generating the excess pressurized fluid, stored pressurized fluid can be used to perform useful work or assist in performing useful work elsewhere in the system. For example, torque assistance motors are motors used to supplement the operation of other motors or pumps. Typically, a torque assistance motor is driven by stored pressurized fluid delivered by an accumulator. The stored pressurized fluid drives the torque assistance motor which may be coupled to a pump or another hydraulic motor to assist in the driving or operation of said pump or motor. Torque assistance motors can also be used to provide torque assistance to the engine itself.

The term peak shaving refers to returning stored energy back to the system when energy demand is high. In hydraulics, peak shaving refers to using stored and pressurized fluid produced by one circuit for operating or supplementing the operation of a component of the same or a different circuit. The use of stored, pressurized fluid for driving a torque assistance motor, assisting in the acceleration or deceleration of a swing motor and providing torque assistance to an engine are just three examples discussed above. Other examples of using stored pressurized fluid generated from peak shaving exist, as will be apparent to those skilled in the art. Given the complexity of today's hydraulic circuits, especially those associated with various types of machines in vehicles, other sources of pressurized fluid for peak shaving purposes may be available and should be exploited.

### SUMMARY

In one aspect, a hydraulic system is disclosed. The system may include a pilot pump, a pilot circuit and a hybrid circuit configured to receive fluid from the pilot pump. They system may further include a selector valve that is moveable between first and second positions to direct pressurized fluid from the pilot pump to a pilot circuit in the first position and to direct pressurized fluid from the pilot pump to a hybrid circuit in the second position. The pilot circuit may include a pilot accumulator for storage of pressurized fluid from the pilot pump. And, the hybrid circuit may include a hybrid accumulator for storage of pressurized fluid from the pilot pump.

In another aspect, a machine is disclosed which may include an engine and a pilot pump mechanically driven by the engine. The machine may further include a selector valve that is moveable between first and second positions to direct pressurized fluid from the pilot pump to a pilot circuit in the first position and to direct pressurized fluid from the pilot pump to a hybrid circuit in the second position. The pilot circuit may include a pilot accumulator for storage of pressurized fluid from the pilot pump when the selector valve is in the first position and the hybrid circuit may include a hybrid accumulator for storage of pressurized fluid from the pilot pump when the selector valve is in the second position. The machine may further include an unloader valve disposed between the hybrid circuit and the selector valve. The unloader valve may be moveable between first and second positions. In the first position, the unloader valve may provide communication between the selector valve and the hybrid accumulator. In the second position, the unloader valve may provide communication between the selector valve and a reservoir.

In another aspect, a method for peak shaving is disclosed wherein the peak shaving diverts pressurized fluid from a pilot pump of a machine that includes a pilot circuit and a hybrid circuit. The disclosed method may include supplying pressurized fluid from the pilot pump to a pilot circuit via a selector valve that is in a first position. The method may further include supplying pressurized fluid from the pilot pump to the hybrid circuit via the selector valve in a second position based on the pressure of the pressurized fluid of the pilot circuit exceeding a first predetermined value. The method may further include storing a hybrid accumulator of the hybrid circuit.

### BRIEF DESCRIPTION OF THE DRAWINGS

FIG. 1 is a side plan view of an exemplary disclosed machine.

FIG. 2 is a schematic illustration of an exemplary disclosed hydraulic or electro-hydraulic system that may be used in conjunction with the machine of FIG. 1 and which illustrates three different uses of stored pressurized fluid as well as combinations thereof.

FIG. 3 is a flow chart illustrating a disclosed method of utilizing excess pressurized fluid of a hydraulic or electro-hydraulic system.

### DESCRIPTION

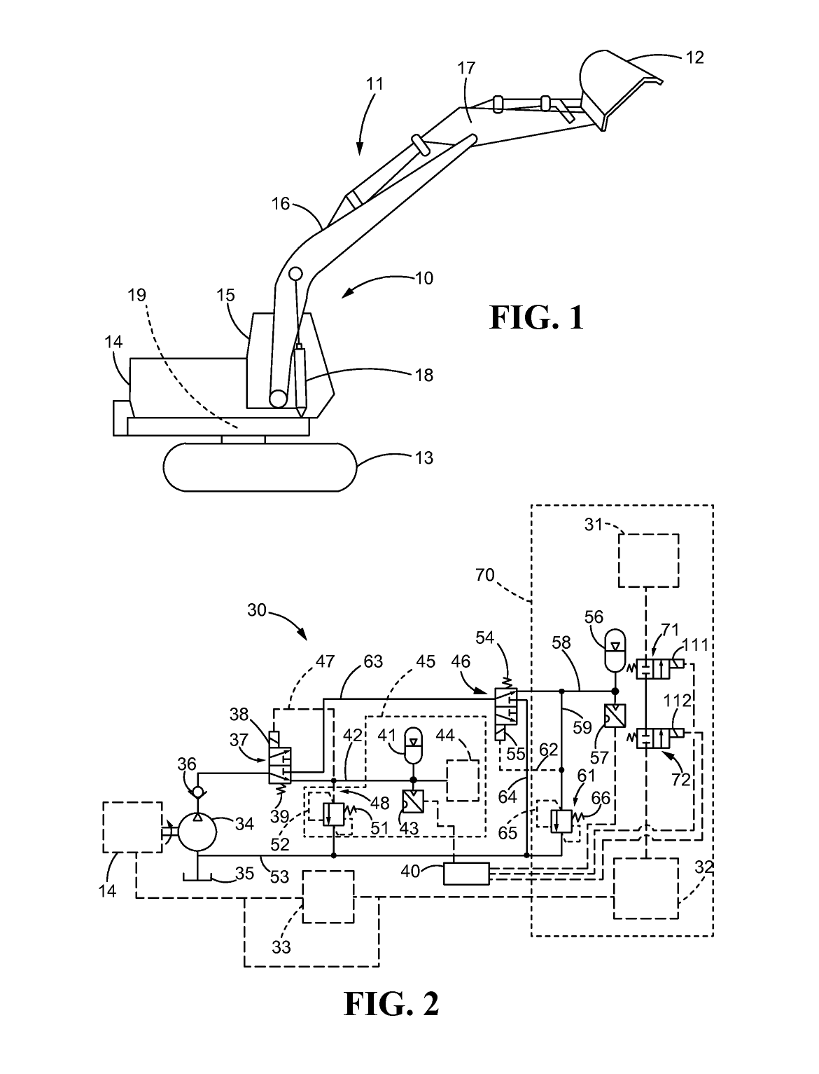

FIG. 1 illustrates an exemplary machine 10 having multiple systems and components that may cooperate to accomplish one or more tasks. The machine 10 may embody a fixed or mobile machine that performs some type of operation associated with an industry such as mining, construction, farming, transportation or other industries known in the art. For example, the machine 10 may be an earth moving machine such as an excavator, as shown in FIG. 1, a wheel loader, a front shovel, a bulldozer, a back hoe, a telehandler, a motor grader, a dump truck or any other type of earth moving machine. The machine 10 may include an implement system 11 configured to move a work tool 12. The machine 10 may further include a drive system 13 for propelling the machine 10, a power source 14 that provides power to the implement system 11 and the drive system 13. The machine 10 may also include an operator station 15 that may be situated for manual control of the implement system 11, the drive system 13 and the power source 14.

The implement system 11 may include a linkage structure acted on by one or more hydraulic actuators such as hydraulic cylinders to move the work tool 12. The hydraulic cylinders may include any device configured to receive pressurized hydraulic fluid and convert a hydraulic pressure and/or flow from the pressurized hydraulic fluid into mechanical force and/or motion. For example, the implement system 11 may also include a boom 16 and a stick 17 for pivotally connecting the work tool 12 to the machine 10. In an embodiment, the boom 16 may be vertically pivotal about a horizontal axis relative to a work surface by one or more hydraulic cylinders 18. Although not shown in FIG. 1, most machines like that shown at 10 in FIG. 1 would include a pair of hydraulic cylinders 18 on either side of the boom 16. The end of the stick 17 may be pivotally connected to the boom 16 and an opposite end of the stick 17 may be connected to the work tool 12. One or more hydraulic cylinders may be provided between the stick 17 and the work tool 12 in order to pivot the work tool 12 and/or between the boom 16 and the stick 17 in order to pivot the stick 17 with respect to the boom 16.

Numerous different work tools 12 may be attachable to a single machine 10 and may be operator controllable. The work tool 12 may include any device used to perform a particular task such as, for example, a bucket, a fork arrangement, a blade, a shovel, a ripper, a dump bed, a broom, a snow blower, a propelling device, a cutting device, a grasping device or any other task-performing device known to those skilled in the art. Although connected to the machine 10 of FIG. 1 to pivot in the vertical direction relative to the body of the machine 10 and to swing in the horizontal direction under the power of a swing motor shown schematically at 19, the work tool 12 may alternatively or additionally rotate, slide, open and close or move in any other manner known to those skilled in the art.

The power source 14 may embody an engine such as, for example, a diesel engine, a gasoline engine, a gaseous fuel-powered engine or any other type of combustion engine known to those skilled in the art. It is contemplated that the power source 14 may alternatively embody a non-combustion source of power such as a fuel cell, a power storage device or any other source known in the art. The power source 14 may produce mechanical or electrical power output that may then be converted to hydraulic power for moving the hydraulic cylinders, one of which is shown at 18 in FIG. 1 and/or one or more pumps of the overall hydraulic system as described below.

The operator station 15 may include devices that receive input from an operator indicative of the desired machine maneuvering. Specifically, the operator station 15 may include one or more operator interface devices (e.g., a joystick, a steering wheel, a pedal, etc.) that are located proximate to an operator seat. The operator interface devices may initiate movement of the machine 10 (e.g., travel and/or tool movement) by producing displacement signals that are indicative of the desired machine maneuvering. As an operator moves the interface device, the operator may affect a corresponding machine movement in a desired direction, with a desired speed and/or with a desired force.

As shown in FIG. 2, a hydraulic system 30 is disclosed that may be implemented in the machine 10 of FIG. 1. As shown schematically in FIG. 2, the hydraulic system 30 may be linked or otherwise in communication with a swing motor circuit 31 and/or a torque assistance motor circuit 32. The torque assistant motor circuit 32 may include a torque assistance motor which, may be linked or otherwise in communication with a power consuming device 33 such as a pump, hydraulic motor or other power consuming device, and/or the torque assistance motor may be coupled, linked or otherwise in communication with the power source 14. Because the hydraulic system 30 is essentially driven by pressurized fluid from a pilot pump 34, it is anticipated that the system 30 could be linked to a single power consuming device such as the swing motor circuit 31, the torque assistance motor circuit 32, or directly to an alternative power consuming device 33 with or without the intervention by a torque assistance motor or the torque assistance motor may be linked or coupled directly to the power source 14. The schematic illustration of the power consuming devices 31, 32, 33 and 14 of FIG. 2 is intended to illustrate versatility of the disclosed hydraulic system 30 and that the hydraulic system 30 may be coupled, linked or otherwise in communication with any one or more of the power consuming devices 31, 32, 33, 14.

Still referring to FIG. 2, the power source 14 is shown mechanically coupled to the pilot pump 34 as shown. The pilot pump 34 may be a single direction, displacement pump as illustrated in FIG. 2. The pilot pump 34 draws fluid from a reservoir 35 which holds hydraulic fluid. Fluid from the pilot pump 34 may pass through an optional check valve 36 before proceeding to a selector valve 37. The selector valve 37 may be a three-way, two-position valve as shown in FIG. 2 with an actuator 38, such as, e.g., hydraulic actuator or a solenoid, and a biasing element 39, such as, e.g., a spring. In FIG. 2, the selector valve 37 is in a first position which provides communication between the pilot pump 34 and a pilot accumulator 41. A line or line 42 connects the selector valve 37 to the pilot accumulator 41. The pilot accumulator 41 may be linked to a pressure sensor 43 which, in turn, may be linked to a controller 40. The pilot accumulator 41 may also be in communication with remaining components 44 of the pilot circuit 45. In other words, pressurized fluid from the pilot accumulator 41 may be used for pilot functionality of the remaining components 44 that form part of the pilot circuit 45.

Fluid pressure in the line 42 may also be used as pilot fluid for shifting the selector valve 37 from the first position shown in FIG. 2 to a second position which provides communication between the pilot pump 34 and an unloader valve 46. Specifically, when pressure in the line 42 reaches a first predetermined value, there is sufficient pressure in the line 42 to provide sufficient pressure in the pilot line 47 to activate the hydraulic actuator 38 of the selector valve 37 to thereby shift the selector valve 37 from its first position shown in FIG. 2 to its second position. The pilot circuit 45 may also include a pilot relief valve 48 that is also connected to or in communication with the line 42. The pilot relief valve 48 may be biased into a normally closed position shown in FIG. 2 by a biasing element 51. However, when pressure in the line 42 reaches a second predetermined value, pressurized fluid communicated by way of the pilot line 52 can create a force sufficient to overcome the force of the biasing element 51 thereby allowing the shifting of the pilot relief valve 48 to an open position and establishing communication between the line 42 and a return line 53. The return line 53 may be configured to serve as a feed for the pilot pump 34 or the fluid proceeds to the reservoir 35. The second predetermined pressure value should be greater than the first predetermined pressure value to provide sufficient pressure to shift the selector valve 37 to the second position prior to actuating the pilot relief valve 42. Thus, fluid will not be sent from the pilot circuit 45 to the reservoir 35 or back to the pilot pump 34 until after the selector valve 37 has been shifted to the second position or the pilot pump 34 is in communication with the unloader valve 46.

The unloader valve 46, like the selector valve 37, may be a three-way, two-position valve with a biasing element 54, such as, e.g., a spring, that maintains the unloader valve 46 in a first position as shown in FIG. 2. The selector valve 37 may also include a hydraulic actuator 55. In the third position shown in FIG. 2, the unloader valve 46 provides communication between the selector valve 37 and a hybrid accumulator 56. Like the pilot accumulator 41, the hybrid accumulator 56 may be linked or coupled to a pressure sensor 57 that may be linked to the controller 40. A line 58 connects the unloader valve 46 to the hybrid accumulator 56. The line 58 may be connected to another line 59 which connects the line 58 to a hybrid relief valve 61 as well as a pilot line 62 that provides communication to the hydraulic actuator 55 of the unloader valve 46.

When the hybrid accumulator 56 becomes fully charged or pressure in the line 58 reaches a first predetermined value, the pressure is communicated through the lines 59, 62 to the hydraulic actuator 55. This action results in the shifting of the unloader valve 46 to a second position which provides communication between the line 63 that leads to the unloader valve 46 and the line 64 that connects the unloader valve 46 to the return line 53. Thus, when the hybrid accumulator 56 becomes sufficiently charged, pressure in the line 58 builds and that pressure that reaches a third predetermined value is communicated to the hydraulic actuator 55 to shift the unloader valve 46 to a second position where fluid proceeding from the pilot pump 34, through the selector valve 37, through the check valve 36 and to the unloader valve 46 is redirected to the line 64 and the return line 53 rather than overcharging the hybrid accumulator 56. Further, if pressure in the line continues to build and said pressure exceeds a third predetermined value, that pressure is communicated through the line 59 to the pilot line 65 which shifts the hybrid relief valve 61 from its normally closed position shown in FIG. 2 to an open position thereby overcoming the bias of the biasing element 66 to provide communication between the line 58 and the return line 53.

As shown in FIG. 2, one or more control valves 71, 72 may be employed downstream of the accumulator 56 that may be linked to the controller 40 for controlling flow to the swing motor circuit 31 or torque assistance motor circuit 32. Further, the hydraulic system 30 may be more of an electro-hydraulic system where the actuators 38 and 55 are controlled by the controller 40 as opposed to being pilot operated as shown in FIG. 2.

As noted above, the hybrid accumulator 56 stores pressurized fluid from the pilot pump 34 and that pressurized fluid can be used to accelerate or decelerate a swing motor of a swing motor circuit 31, provide pressurized fluid to a hydraulic motor of a torque assistance motor circuit 32 which, in turn, may be used to drive an additional power consuming device 33 or the torque assistance motor 32 may be coupled directly to the power source 14 for providing torque assistance to the power source 14. Further, any one or more combinations of the above may be employed, as will be apparent to those skilled in the art.

### INDUSTRIAL APPLICABILITY

The disclosed hydraulic system 30 may have particular applicability with machines to allow recovery and/or reuse of potential energy associated with the pilot pump 34 which may run constantly as it is coupled to the power source 14. After the pilot pump 34 is sufficiently utilized to charge the pilot accumulator 41, the selector valve 37 may be shifted to redirect flow from the pilot pump 34 to the hybrid circuit 70 by way of the unloader valve 46. The hybrid circuit 70 may include a hybrid accumulator 56. Pressurized fluid is stored in the hybrid accumulator 56 which may then be later used to provide pressurized fluid to any one or more of a variety of components such as a swing motor 31, a torque assistance motor 32 or any other power consuming component. If a torque assistance motor 32 is utilized, the torque assistance motor 32 may be used to deliver mechanical energy to another power consuming component 33 or provide additional mechanical energy to the power source 14. Further, any combination of one or more of the above concepts may be employed.

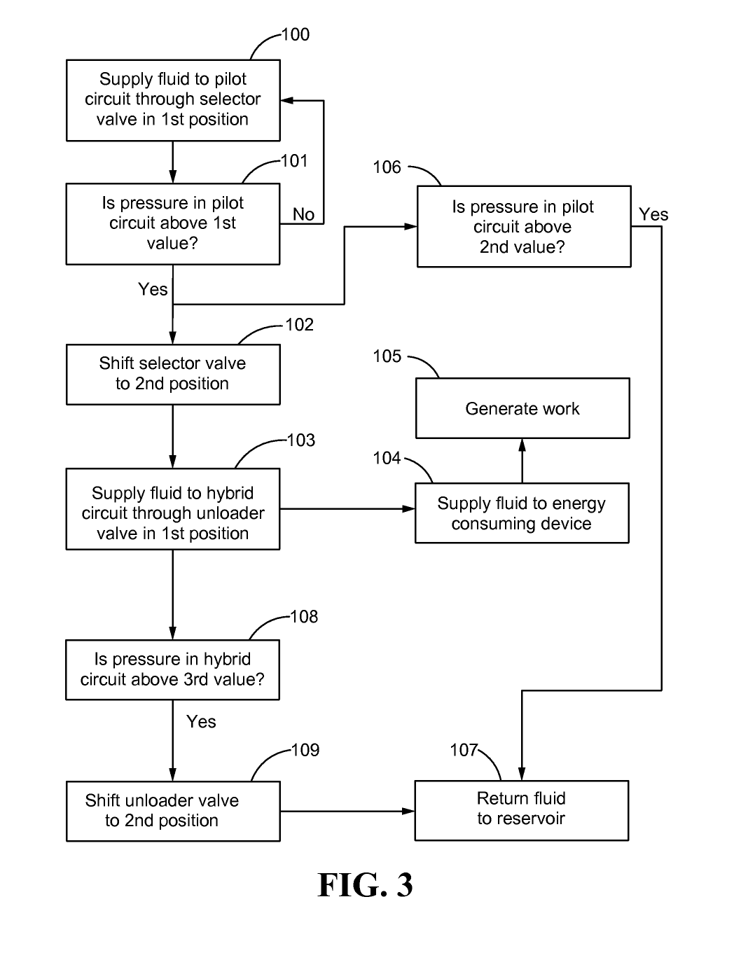

One disclosed method is illustrated in the flow chart of FIG. 3. Fluid is supplied to the pilot circuit 45 through the selector valve 37 at step 100. If the pressure of the pilot circuit 45 exceeds a first predetermined value at step 101, the selector valve 37 is shifted from its first position to its second position at step 102 to direct fluid to the hybrid circuit 70 at step 103 where the fluid may be stored in the hybrid accumulator 56 and/or supplied to an energy consuming device such as a swing motor 31 or torque assistance motor 32 at step 104 for generating useful work at step 105. Simultaneously or periodically, if pressure in the pilot circuit 45 rises to a second predetermined value at step 106, the pilot relief valve 48 is opened and fluid is returned to the reservoir at step 107 as shown in FIG. 3. If the pressure in the hybrid circuit 70 exceeds a third predetermined value at step 108, the unloader valve 46 is shifted to its second position at step 109 so fluid may be returned to the reservoir 35 at step 107. The above actions may be performed in a purely hydraulic system, a purely electrohydraulic system or the combination electro-hydraulic system 30 as illustrated in FIG. 1 with the controller 40 linked to the pressure sensor 57 and the actuators 111, 112 of the control valves 71, 72 for purposes of controlling flow to the swing motor 31 and/or the torque assistance motor 32.

1. A hydraulic system comprising:
a pilot pump,
a pilot circuit and a hybrid circuit each to receive pressurized fluid from the pilot pump;
a selector valve movable between first and second positions to direct pressurized fluid from the pilot pump to the pilot circuit in the first position and to direct pressurized fluid from the pilot pump to the hybrid circuit in the second position;
the pilot circuit including a pilot accumulator for storage of pressurized fluid from the pilot pump; and
the hybrid circuit including a hybrid accumulator for storage of pressurized fluid from the pilot pump.

2. The system of claim 1 wherein the selector valve is configured to be shifted from the first position to the second position when pressure in the pilot accumulator reaches a first predetermined value.

3. The system of claim 1 further including a pilot relief valve disposed between the selector valve and the pilot accumulator, the pilot relief valve is configured to provide communication between the selector valve and a reservoir and between the pilot accumulator and the reservoir, the pilot relief valve being configured to be normally closed when the pilot accumulator is at a pressure at or below a first predetermined value.

4. The system of claim 3 wherein the pilot relief valve is configured to be normally closed until the pressure in a line between a pilot accumulator and the pilot relief valve reaches a second predetermined value, the second predetermined value being greater than the first predetermined value.

5. The system of claim 1 further including a check valve disposed between the pilot pump and the selector valve.

6. The system of claim 2 further including an unloader valve disposed between the hybrid accumulator and the selector valve, the unloader valve configured to relieve fluid from the pilot pump to a reservoir when pressure in the hybrid accumulator reaches a third predetermined value.

7. The system of claim 6 wherein the unloader valve is configured to be normally in a first position to provide communication between the selector valve and the hybrid accumulator, and is movable to a second position to provide communication between the unloader valve and a reservoir return line, the unloader valve is configured to be shifted from the first position to the second position when pressure in the hybrid accumulator reaches the third predetermined value.

8. The system of claim 7 further including a hybrid relief valve disposed between the unloader valve and the hybrid accumulator, the hybrid relief valve configured to couple the hybrid accumulator and the unloader valve to a reservoir return line when the unloader valve is in the second position,
the hybrid relief valve configured to be normally closed until the pressure in a line between the hybrid accumulator and the hybrid relief valve reaches the third predetermined value.

9. The system of claim 6 further including a hybrid relief valve disposed between the unloader valve and the hybrid accumulator, the hybrid relief valve configured to connect the hybrid actuator and the unloader valve to a reservoir return line,
the hybrid relief valve being normally closed until the pressure in a line between the hybrid accumulator and the hybrid relief valve reaches the third predetermined value.

10. The system of claim 1 wherein the hybrid accumulator is in communication with a swing motor circuit.

11. The system of claim 1 wherein the hybrid accumulator is in communication with a torque assistance motor circuit.

12. The system of claim 11 wherein the torque assistance motor circuit is coupled to an engine.

13. The system of claim 11 wherein the torque assistance motor circuit is coupled to a power consuming device.

14. A machine comprising:
an engine;
a pilot pump mechanically driven by the engine;
a selector valve configured to be movable between first and second positions to direct pressurized fluid from the pilot pump to a pilot circuit in the first position and to direct pressurized fluid from the pilot pump to a hybrid circuit in the second position;
the pilot circuit including a pilot accumulator for storage of pressurized fluid from the pilot pump when the selector valve is in the first position; and
the hybrid circuit including a hybrid accumulator for storage of pressurized fluid from the pilot pump when the selector valve is in the second position;
an unloader valve disposed between the hybrid circuit and the selector valve, the unloader valve being movable between first and second positions, in the first position, the unloader valve providing communication between the selector valve and the hybrid accumulator, and in the second position, the unloader valve configured to provide communication between the selector valve and a reservoir.

15. The machine of claim 14 wherein the selector valve is shifted from the first position to the second position when pressure in the pilot accumulator reaches a first predetermined value.

16. The machine of claim 15 further including a pilot relief valve disposed between the selector valve and the pilot accumulator, the pilot relief valve configured to provide communication between the selector valve and the reservoir and between the pilot accumulator and the reservoir, the pilot relief valve being normally closed until the pressure in a line between a pilot accumulator and the pilot relief valve reaches a second predetermined value, and
wherein the second predetermined value is greater than the first predetermined value.

17. The machine of claim 14 wherein the unloader valve is shifted to the second position when pressure in the hybrid accumulator reaches a third predetermined value.

18. The machine of claim 17 further including a hybrid relief valve disposed between the unloader valve and the hybrid accumulator, the hybrid relief valve connecting the hybrid actuator and the unloader valve to a reservoir return line when the unloader valve is in the second position,
the hybrid relief valve configured to be closed until the pressure in a line between the hybrid accumulator and the hybrid relief valve reaches the third predetermined value.

19. The machine of claim 14 wherein the hybrid accumulator is in communication with an energy consuming component of the machine.

20. A method for peak shaving pressurized fluid from a pilot pump of a machine that includes a pilot circuit and a hybrid circuit, the method comprising:
supplying pressurized fluid from the pilot pump to the pilot circuit via a selector valve in a first position;
supplying pressurized fluid from the pilot pump to the hybrid circuit via the selector valve in a second position based on the pressure of the pressurized fluid of the pilot circuit exceeding a first predetermined value;
storing pressurized fluid in a hybrid accumulator of the hybrid circuit.
